(19) United States
(12) Patent Application Publication
(10) Pub. No.: US 2024/0066551 A1
(43) Pub. Date: Feb. 29, 2024

(54) METHOD FOR POST-TREATMENT OF AN ADDITIVE MANUFACTURED OBJECT

(71) Applicant: ELKEM SILICONES SHANGHAI CO., LTD., SHANGHAI (CN)

(72) Inventors: Liya JIA, SHANGHAI (CN); Yuanzhi YUE, SHANGHAI (CN); Zhuo XU, SHANGHAI (CN)

(21) Appl. No.: 18/270,632

(22) PCT Filed: Dec. 31, 2020
(86) PCT No.: PCT/CN2020/142044

§ 371 Date: Jun. 30, 2023

(51) Int. Cl. B05D 3/06; B05D 1/18; B29C 64/30

(52) U.S. Cl. CPC B05D 3/065; B05D 1/18; B29C 64/30; B33Y 40/20

(57) ABSTRACT

A method of post treatment of the surface of an additive manufactured object is described. The method can include steps of coating at least part of the surface with a curable silicone composition and then curing the coating at room temperature or by heat or UV radiation. The curable silicone composition can have a viscosity in a range from 300 mPa·s to 500 000 mPa·s. A 3D printing method is also described that includes this method and also a post treatment agent including the curable silicone composition.

### TECHNICAL FIELD

The invention relates to a method for post treatment of an additive manufactured object, in particular its surface, with a curable silicone composition, a post-treatment agent and also a 3D printing process containing such a method.

### BACKGROUND OF THE INVENTION

Additive manufacturing (AM) techniques, is also called 3D printing, which have been used in various fields, especially healthcare, automotive, robots or aerospace etc. The 3D model is obtained via computer-aided design (CAD), which is translated into physical objects by 3D printing processes. The printing process can meet customized requirements and have higher efficiency. At present, different materials such as metal, polymers or ceramic can be printed via different techniques.

However, additive manufacturing technology is based on a layer by layer printing process, which brings about easily the step effect on the surface or contour of the printed objects. Due to the layer by layer printing or deposition in the additive manufacturing process, the surface or the contour of the object usually has a wrinkle or wave like appearance which is referred as a step effect. The step effect will lead to unacceptable appearance and even probably harm the mechanical properties in some applications. In order to remove the step effect, different methods are employed after printing process. For metallic materials, polishing, anodic oxidation, sand blasting, powder coating and electroplating are usually used to obtain a smooth surface and contour. As for the plastic or polymeric objects, some mechanical treatments like sand blasting or polishing may be used in the surface finishing to remove the step effects.

A polymeric coating is preferred in the post treatment process. But in the practice, it is still difficult to select out proper polymeric coatings for removing the step effect on the surface or contour of the additive manufactured object, meanwhile satisfying the requirements on the mechanical and adhesion properties.

US 2020/0238601 A1 relates to a method for the additive manufacturing of an object using a 3D-printing device. The models after 3D printing according to the inventive method may be coated locally or wholly, so as to optimize the surface properties. The properties which may be optimized by coating include, for example, surface roughness, coefficient of friction, color, component transparency, reduction in the step effect of 3D printing, application of a surface layer differing in materials terms from the component itself, etc. However, it fails to discuss deeply about the coatings which may be used to reduce the step effect.

US10625292B2 discloses a system treating uneven surfaces of additive manufactured objects to improve the transparency and glossiness of the surfaces. The system operates a sprayer to apply fluid material used to form the uneven surface to the uneven surface to smooth the surface or the system operates an actuator to dip the additive manufactured object into a bath of such a fluid material. No information on the chemical composition of useful fluid material.

US20100104804A1 discloses an optical three-dimensional shaped item excelling in the smoothness of molding end face. An unevenness degree of at least a part of an uneven portion in a fabricated edge of the three-dimensional object is reduced by segregation of a component included in the actinic radiation-curable resin composition and/or a material originated from the component, so that the fabricated edge is smoothed.

All of these prior art references do not provide any technical solution dealing with selecting out proper polymeric coatings for the post treatment of exterior surfaces of the additive manufactured objects, in particular based on the polymeric or plastic material, so as to remove the step effect without impairing the adhesion and mechanical properties of the surface or the printed object.

### SUMMARY OF INVENTION

The inventors of the instant application have surprisingly found that the step effect occurring at the exterior surface of the additive manufactured object may be well removed if a silicone coating can be applied on the surface to be treated and cured at a proper rate which should be sufficiently rapid but in the meantime not causing any harms to the mechanical properties.

Therefore, in one aspect, the invention relates to a method of post treatment of the surface of an additive manufactured object, comprising the steps of coating at least part of the surface with a curable silicone composition and then curing the coating at room temperature or by heat or UV radiation, characterized in that the curable silicone composition has the viscosity in a range from 300 to 500 000 mPa·s, preferably 300 to 200 000 mPa·s or 500 to 90 000 mPa·s, such as 800 to 100 000 mPa·s or 1000 to 50 000 mPa·s or to 20 000 mPa·s.

With the inventive method, the step effect may be greatly or totally removed, meaning that the degree of the unevenness of the post treated surface is reduced and a smooth contour can be obtained, in particular at the fabricated edge of the additive manufactured object. The required viscosity control is essential in the invention. If exceeding the viscosity of 500 000 mPa.s, the operation will become difficult or complicated and the coating process will be adversely affected, meanwhile difficult to obtain an even and smooth coating that may remove the step effect. With unduly low viscosity e.g. 300 mPa·s, the mechanical property will be harmed.

In another aspect, the invention relates to a 3D printing process containing the post-treatment method as above, comprising the following steps:
a) fabricating an additive manufactured object having an exterior contour or surface of polymeric or plastic material, preferably an additive manufactured object made of polymeric or plastic material,

b) coating at least part of the surface of the fabricated object with a curable silicone composition as defined above, and
c) curing the coating at room temperature or by heat or UV radiation.

### EMBODIMENTS OF INVENTION

All the viscosities under consideration in the present specification correspond to a dynamic viscosity magnitude that is measured, in a manner known per se, at about 25° C., with a machine of e.g. Brookfield type. As regards to fluid products, the viscosity under consideration in the present specification is the dynamic viscosity at about 25° C., known as the “Newtonian” viscosity, i.e. the dynamic viscosity that is measured, in a manner known per se, at a sufficiently low shear rate gradient so that the viscosity measured is independent of the rate gradient.

In the present disclosure, the useful additive manufacturing material (or referred as building material) may contain and preferably based on or consisting mainly of the polymer material, especially curable silicone composition. The silicone compositions suitable for additive manufacturing process are well known per se and in principle may be any curable silicone composition that has the siloxane units based backbone and can be used for producing a silicone elastomer article, such as the liquid silicone rubber (LSR) which has been already used widely. When using different printing materials to make an additive manufactured object which thus may be composed of several parts based on different materials, at least part of its exterior surface is preferably based on the polymeric or plastic material, in particular the silicone rubber.

The suitable silicone composition for the additive manufacturing building material, including silicone rubber, may be curable chemically via condensation or addition crosslinking reactions. In one exemplary embodiment, such a curable silicone composition usually comprises:
(A) a polyorganosiloxane polymer containing the siloxane unit represented by the formula (S−1) and optionally formula (S−2)

R^{S}_{a′}Z^{S}_{b′}SiO_{[4-(a′+b′)]/2} (S−1)
in which
R^{S} is a reactive group like hydroxyl, alkoxy, alkenyl, and alkynyl groups,
Z^{S} may be the same or different and represent a monovalent non-reactive hydrocarbon radical having for example from 1 to 30 carbon atoms, preferably selected from alkyl and aryl groups, a′ is 1, 2 or 3, b′ is 0, 1 or 2 and the sum of a′+b′ is 1, 2 or 3;

Z^{S1}_{c′}SiO_{(4-c′)/2} (S−2)
in which:
c′ =0, 1, 2 or 3,
Z^{S1} may be identical or different and represent a monovalent non-reactive hydrocarbon radical having for example from 1 to 30 carbon atoms, preferably selected from alkyl and aryl groups,
(B) a cross-linking organosilicon compound having at least 2 silicon-bonded reactive groups;
(C) a catalyst capable of promoting the reaction between component (A) and component (B).

### 3D Printing Disclosure

3D printing is generally associated with a host of related technologies used to fabricate physical objects from computer generated, e.g. computer-aided design (CAD), data sources.

This disclosure generally incorporates ASTM Designation F2792 - 12a, “Standard Terminology for Additive Manufacturing Technologies Under this ASTM standard.

“3D printer” is defined as “a machine used for 3D printing” and “3D printing” is defined as “the fabrication of objects through the deposition of a material using a print head, nozzle, or another printer technology.”

“Additive manufacturing (AM)” is defined as “a process of joining materials to make objects from 3D model data, usually layer upon layer, as opposed to subtractive manufacturing methodologies. Synonyms associated with and encompassed by 3D printing include additive fabrication, additive processes, additive techniques, additive layer manufacturing, layer manufacturing, and freeform fabrication.” Additive manufacturing (AM) may also be referred to as rapid prototyping (RP). As used herein, “3D printing” is generally interchangeable with “additive manufacturing” and vice versa.

“Printing” is defined as depositing of a material, here a silicone composition, using a print head, nozzle, or another printer technology.

In this disclosure “3D or three dimensional article, object or part” means an article, object or part obtained by additive manufacturing or 3D printing as disclosed above.

In general, all 3D printing processes have a common starting point, which is a computer generated data source or program which may describe an object. The computer generated data source or program can be based on an actual or virtual object. For example, an actual object can be scanned using a 3D scanner and scan data can be used to make the computer generated data source or program. Alternatively, the computer generated data source or program may be designed from scratch.

The computer generated data source or program is typically converted into a standard tessellation language (STL) file format; however other file formats can also or additionally be used. The file is generally read into 3D printing software, which takes the file and optionally user input to separate it into hundreds, thousands, or even millions of “slices.” The 3D printing software typically outputs machine instructions, which may be in the form of G-code, which is read by the 3D printer to build each slice. The machine instructions are transferred to the 3D printer, which then builds the object, layer by layer, based on this slice information in the form of machine instructions. Thicknesses of these slices may vary.

An extrusion 3D printer is a 3D printer where the material is extruded through a nozzle, syringe or orifice during the additive manufacturing process. Material extrusion generally works by extruding material through a nozzle, syringe or orifice to print one cross-section of an object, which may be repeated for each subsequent layer. The extruded material bonds to the layer below it during cure of the material.

In one preferred embodiment, the method for additive manufacturing a three-dimensional elastomer article uses an extrusion 3D printer. The additive manufacturing material like silicone compositions are extruded through a nozzle. The nozzle may be heated to aid in dispensing the silicone composition.

The average diameter of the nozzle defines the thickness of the layer. In an embodiment, the diameter of the layer is comprised from 5 to 5000 μm, preferably from 10 to 2000 μm and most preferably from 50 to 1000 μm.

The distance between the nozzle and the substrate is an important parameter to assure good shape. Preferably it is comprised from 60 to 150%, more preferably from 80 to 120% of the nozzle average diameter.

The silicone composition to be dispensed through the nozzle may be supplied from a cartridge-like system. The cartridge may include a nozzle or nozzles with an associated fluid reservoir or fluids reservoirs. It is also possible to use a coaxial two cartridges system with a static mixer and only one nozzle. Pressure will be adapted to the fluid to be dispensed, the associated nozzle average diameter and the printing speed.

Because of the high shear rate occurring during the nozzle extrusion, the viscosity of the silicone compositions is greatly lowered and so permits the printing of fine layers.

Cartridge pressure could vary from 1 to 20 bars, preferably from 2 to 10 bar and most preferably from 2.5 to 8 bar. An adapted equipment using aluminum cartridges shall be used to resist such a pressure.

The nozzle and/or build platform moves in the X-Y (horizontal plane) to complete the cross section of the object, before moving in the Z axis (vertical) plane once one layer is complete. The nozzle has a high XYZ movement precision such as 10˜300 μm. After each layer is printed in the X, Y work plane, the nozzle is displaced in the Z direction only far enough that the next layer can be applied in the X, Y work place. In this way, the object which becomes the 3D article is built one layer at a time from the bottom upwards.

As disclosed before, the distance between the nozzle and the previous layer is an important parameter to assure good shape. Preferably, it should be comprised from 60 to 150%, preferably from 80 to 120% of the nozzle average diameter.

Advantageously, printing speed is comprised between 0.1 and 100 mm/s, preferably between 1 and 50 mm/s to obtain the best compromise between good accuracy and manufacture speed.

“Material jetting” is defined as “an additive manufacturing process in which droplets of build material are selectively deposited.” The material is applied with the aid of a printing head in the form of individual droplets, discontinuously, at the desired location of the work plane (Jetting). 3D apparatus and a process for the step-by-step production of 3D structures with a printing head arrangement comprising at least one, preferably 2 to 200 printing head nozzles, allowing the site-selective application where appropriate of a plurality of materials. The application of the materials by means of inkjet printing imposes specific requirements on the viscosity of the materials.

In a material 3D jetting printer one or a plurality of reservoirs are subject to pressure and being connected via a metering line to a metering nozzle. Upstream or downstream of the reservoir there may be devices which make it possible for multicomponent addition-crosslinking silicone compositions to be homogeneously mixed and/or to evacuate dissolved gases. One or a plurality of jetting apparatuses operating independently of one another may be present, to construct the elastomer article from different addition-crosslinking silicone compositions, or, in the case of more complex structures, to permit composite parts made from silicone elastomers and other plastics,

Because of the high shear rate occurring in the metering valve during the jetting metering procedure, the viscosity of such silicone compositions is greatly lowered and so permits the jetting metering of very fine microdroplets. After the microdrop has been deposited on the substrate, there is a sudden reduction in its shear rate, and so its viscosity climbs again. Because of this, the deposited drop rapidly becomes of high viscosity again and permits the shape-precise construction of three-dimensional structures.

The individual metering nozzles can be positioned accurately in x-, y-, and z-directions to permit precisely targeted deposition of the silicone composition drops on the substrate or, in the subsequent course of formation of shaped parts, on the silicone rubber composition which has already been placed and which optionally has already been crosslinked.

Typically, the 3D printer utilizes a dispenser, e.g. a nozzle or print head, for printing the particular curable silicone composition. Optionally, the dispenser may be heated before, during, and after dispensing the silicone composition. More than one dispenser may be utilized with each dispenser having independently selected properties.

In one embodiment, this method can use support material to build the object. If the object is printed using support material or rafts, after the printing process is complete, they are typically removed leaving behind the finished object.

However, as discussed above, either extruding or jet printing in the additive manufacturing technology usually brings out an article with a surface having a step effect which should be removed in the post treatment.

### Silicone Composition used for the Post Treatment

In the inventive method, an treatment silicone composition satisfying the viscosity requirement as stated above may be used for the post treatment of the exterior surface or fabricated edges with stage appearance of the additive manufactured objects, by coating it onto the surface to be treated or at least part of it and then curing it at room temperature or by heat or UV radiation.

The term “coating” used herein is well known to the skilled person and refers to all application forms or ways which allows the composition to cover sufficiently the area to be post treated of the exterior surface or edges. Examples of coating include dip coating for example dipping into a treatment bath of the silicone composition, spraying coating, curtain coating or spinning coating or any other manners, preferably dip coating.

In one preferable embodiment, the inventor has further found that the curing rate and curing condition of the silicone composition which affect the removal of step effect may be further optimized by controlling the gel time of the curable silicone composition for the room temperature or heat curing in a range from 0.1 second to 15 hours, preferably 1 second to 0.5 hour, more preferably 5 seconds to 10 mins such as 10 seconds to 2 mins; and for the UV radiation curing in a range from 0.001 second to 1 hour, preferably 0.01 second to 20 min such as 0.1 second to 1 min. A too long gel time is not beneficial to the curing process or make it uneconomic, resulting in possibly also an uneven coating that makes removal the step effect less effective.

The term “gel time” refers to the time from the beginning of the mixing at the room temperature or by heat or under UV radiation until the curable material such as resin stops forming strings by contact with the pick. The gel time can be a useful measure for reflecting the ability or potential of a curable material to be cured rapidly. It can be determined in a similar method according to the standard D2471-99 for the thermosetting resin.

In one beneficial embodiment, the inventive silicone composition used for post treatment may be the curable silicone composition comprising
(A) at least one organopolysiloxane compound A comprising, per molecule at least two C₂—C₆ alkenyl radicals bonded to silicon atoms,
(B) at least one organohydrogenopolysiloxane compound B comprising, per molecule, at least two hydrogen atoms bonded to an identical or different silicon atom, and
(C) at least one catalyst C comprising at least one metal from the platinum group or the compound thereof.

### Organopolysiloxane Compound A

The organopolysiloxane compound A comprises, per molecule, at least two C₂—C₆ alkenyl radicals bonded to silicon atoms, with the alkenyl groups being at any position of the main chain of polysiloxane, for example, at ends or in the middle of the molecular chain or both.

Preferably, the organopolysiloxane compound A comprises:
(I) at least two siloxy units of Formula (I−1),

R¹Z_{b}SiO_{[4-(a+b)]/2} (I−1)
wherein
R¹ which may be identical or different, represents a linear or branched C2-12, preferably C2-6 alkenyl group, most preferably vinyl or allyl,
Z represents identically or differently a univalent hydrocarbyl group with 1 to 30, preferably 1 to 12 carbon atoms, preferably selected from C1-8 alkyl groups including alkyl groups optionally substituted with at least one halogen atom, and chosen from the group formed by methyl, ethyl, propyl, 3,3,3-trifluoropropyl, phenyl,
a is 1 or 2, b is 0, 1 or 2, and the sum of a and b is 1, 2 or 3, and optionally (II) other siloxy units of Formula (1-2)

$$Z \text{?} SiO \text{?} \qquad ( I - 2 )$$

$$\text{?} \text{indicates text missing or illegible when filed}$$

wherein
Z has the meanings as indicated above and c is 0, 1, 2 or 3.

In a preferred embodiment, Z can be selected from methyl, ethyl, propyl, 3,3,3-trifluoropropyl, phenyl, xylyl and tolyl and the like. Preferably, at least 60 mol% (or expressed by number) of group Z is methyl.

In a preferable embodiment, in formula (1-1) a=1 and a+b=2 or 3 and in formula (1-2) c=2 or 3.

These organopolysiloxane compound A may have a linear, branched or cyclic structure.

When they are linear polymers, they are essentially formed from siloxyl units “D” chosen from the group formed by the siloxyl units R₂SiO_{2/2}, RZSiO_{2/2} and Z₂SiO_{2/2}, and from siloxyl units “M” chosen from the group formed by the siloxyl units R₃SiO_{1/2}, RZ₂SiO_{1/2}, R₂ZSiO_{1/2} and Z₃SiO_{1/2}. The symbols R and Z are as described above.

As examples of end units “M”, mention may be made of trimethylsiloxy, dimethylvinylsiloxy or dimethylhexenylsiloxy groups.

As examples of units “D”, mention may be made of dimethylsiloxy, methylvinylsiloxy, methylbutenylsiloxy, methylhexenylsiloxy, methyldecenylsiloxy or methyldecadienylsiloxy groups.

Without impairing the purpose of the present invention, the molecular chain may further contain branched siloxy units, but in the proportion preferably not exceeding 10%, more preferably not exceeding 5% in the organopolysiloxane compound A.

The organopolysiloxane compound A may be monomer, oligomer or polymer. In one embodiment, they preferably have a dynamic viscosity from about 1 to 10000000 mPa·s at 25° C., generally from about 200 to 1000000 mPa·s at 25° C. It can also be a gum with greater viscosity. In the present application, all viscosities relate to dynamic viscosities values and can be measured for example in a known manner using a Brookfield viscometer at 20° C. If the viscosity is too high to be measured by Brookfield instrument, it can be measured by Ubbelohde viscometer.

The organopolysiloxane compound A may have the alkenyl content of 0.0001˜40 wt. %, preferably 0.001˜35 wt %, more preferably 0.01˜30 wt %, based on the total weight of organopolysiloxane compound A.

When they are cyclic organopolysiloxanes, they are formed from siloxyl units “D” having the following formulae: R₂SiO_{2/2}, Z₂SiO_{2/2} or RZSiO_{2/2}, which may be of the dialkylsiloxy, alkylvinylsiloxy or alkylsiloxy type. Examples of such siloxyl units have already been mentioned above. Said cyclic organopolysiloxane compound A is not limited monomer, oligomer or polymer. In one embodiment, they preferably have a viscosity from about 1 to 500000 mPa·s at 25° C.

### Organohydrogenpolvsiloxane Compound B

According to a preferred embodiment, the organohydrogenopolysiloxane compound B is an organopolysiloxane containing at least two hydrogen atoms per molecule, bonded to an identical or different silicon atom, so as to perform crosslinking reaction with organopolysiloxane compound A.

According to the present invention, the SiH group in organohydrogenopolysiloxane compound B can be at any position of the main chain of polysiloxane, for example, at ends or in the middle of the molecular chain or both.

Advantageously, the organohydrogenopolysiloxane compound B is an organopolysiloxane comprising:
(i) at least two siloxyl units and preferably at least three siloxyl units having the following formula:

H_{d}R²ₑSiO_{[4-(d+e)]/2} (II−1)
wherein
R² represents identically or differently a monovalent linear, branched or cyclic alkyl group containing from 1 to 30 carbon atoms, preferably selected from C1-8 alkyl groups including alkyl groups optionally substituted with at least one halogen atom, and from aryl groups, especially C6-20 aryl groups, and chosen from the group formed by methyl, ethyl, propyl, 3,3,3-trifluoropropyl, and
(ii) optionally at least one siloxyl unit having the following formula:

R²_{f}SiO_{(4-f)/2} (II−2)
in which:
R² has the meanings as indicated above and f is 0, 1, 2 or 3.

In a more preferred embodiment, R² can be selected from methyl, ethyl, propyl, 3,3,3-trifluoropropyl, phenyl, xylyl and tolyl.

The organohydrogenopolysiloxane compound B may be formed solely from siloxyl units of formula (II−1) or may also comprise units of formula (II−2). It may have a linear, branched or cyclic structure.

Examples of siloxyl units of formula (II−1) are especially the following units: H(CH3)2SiO1/2, and HCH3SiO_{2/2}.

When they are linear polymers, they are essentially formed from:
siloxyl units “D” chosen from the units having the following formulae R²₂SiO_{2/2} or R²HSiO_{2/2},
   and
siloxyl units “M” chosen from the units having the following formulae R²₃SiO_{1/2} or R²₂HSiO_{1/2}.

These linear organopolysiloxanes may be oils with a dynamic viscosity from about 1 to 1000000 mPa·s at 25° C., generally from about 1 to 50000 mPa·s at 25° C. or preferably from about 5 to 10000 or 5000 mPa·s at 25° C.

Examples of organohydrogenopolysiloxane compound B include linear or cyclic compounds, for example, dimethyl polysiloxane having hydrogenated dimethyl siloxy end group, copolymer having (dimethyl)(hydrogenmethyl) polysiloxane units having trimethyl siloxy end group, copolymer having (dimethyl)(hydrogenmethyl) polysiloxane units having hydrogenated dimethyl siloxy end group, hydrogenated methyl polysiloxane having trimethylsiloxy end group, and cyclic hydrogenated methyl polysiloxane.

The organohydrogenopolysiloxane compound B may be a three-dimensional net-like organohydrogensiloxane resin containing at least two different units selected from the group comprising or consisting of
units M of formula R′₃SiO_{1/2},
units D of formula R′₂SiO_{2/2},
units T of formula R′SiO_{3/2} and
units Q of formula SiO_{4/2}, wherein R′ represents hydrogen atom or a monovalent hydrocarbonyl group having from 1 to 20 carbon atoms, and with the proviso that at least one of these siloxane units is the siloxane unit T or Q, preferably Q, and at least one of the siloxane units M, D and T comprises a hydrogen atom.

In one preferred embodiment, the mole ratio of M unit to Q unit in said organohydrogensiloxane resin is from 0.5 to 8 mol/mol, preferably from 0.5 to 6 mol/mol, more preferably from 0.8 to 5 mol/mol.

In another exemplary embodiment, the mass content of SiH is between 0.001 wt % and 70 wt %, preferably between 0.5 wt % and 60 wt% and more preferably between 1.0 wt % and 50 wt %, based on the total weight of component B.

### Catalyst C

Catalyst C comprising at least one metal from the platinum group or the compound thereof. The platinum metal catalyst is well known in organosilicon field and commercially available. In addition to platinum, the platinum group metal can further comprise ruthenium, rhodium, palladium, osmium and iridium. The catalyst can be composed of following components: a platinum group metal or compound thereof or a combination thereof. Examples of such a catalyst include but not limited to: platinum black, chloroplatinic acid, platinum dichloride, reaction product of chloroplatinic acid with monohydric alcohol. Preferably, compounds of platinum and rhodium are used. Usually, the preferred catalyst is platinum.

Some suitable complexes and compounds of platinum are disclosed in, for example, patents US3159601A, US3159602A, US3220972A, EP0057459A, EP0188978A and EP0190530A, and especially a complex of platinum and vinyl organosiloxane as disclosed in, for example, patents US3419593A, US3715334A, US3377432A and US3814730A can be used. All these documents are incorporated in its entirety in the present specification by reference.

The platinum catalyst ought preferably to be used in a catalytically sufficient amount, to allow sufficiently rapid crosslinking at room temperature. Typically, 1 to 10000 ppm by weight of the catalyst are used, based on the amount of Pt atom, preferably 1 to 100 ppm by weight, more preferably 1 to 50 ppm by weight, relative to the total weight of the treatment silicone composition.

In addition, UV curing may be advantageous in some cases. Thus, the silicone composition may contain those catalysts suitable for UV curing, such as platinum-based photo-curing catalysts. Examples of suitable platinum-based photo-curing catalysts include: bis(acetylacetonate)platinum, trimethyl(acetylacetonate)platinum complex, trimethyl(2,4-pentanedione)platinum complex, trimethyl(3,5-heptanedione) platinum complex, trimethyl(methyl acetoacetate) platinum complex, bis(2,4-pentanedione) platinum complex , bis(2,4-hexanedione) platinum complex, bis(2,4-heptanedione) platinum complex, bis(3,5-heptanedione) platinum complex and bis(1-phenyl-1,3-butanedione) platinum complex and the like.

In the case of UV curing, the amount of the platinum-based photo-curing catalyst is 1-50000 ppm, preferably 5-1000 ppm, based on the total weight of the entire silicone composition, based on platinum metal.

If necessary, when using the platinum-based photo-curing catalyst, an appropriate solvent can be added to dissolve it. Suitable solvents include 2-(2-butoxyethoxy) ethyl acetate, diethylene glycol butyl ether acetate, various halogenated hydrocarbons and the like. The amount of the solvent is preferably sufficient to dissolve the catalyst.

### Reinforcing Silica Filler D

To allow a sufficiently high mechanical strength, it is advantageous to include in the post treatment silicone compositions the silica fine particles as reinforcing fillers D, which may be at least partly surface treated. Precipitated and fumed silicas and mixtures thereof can be used. The specific surface area of these actively reinforcing fillers ought to be at least 50 m²/g and preferably in the range from 100 to 400 m²/g as determined by the BET method. Actively reinforcing fillers of this kind are very well-known materials within the field of the silicone rubbers. The stated silica fillers may have hydrophilic character or may have been hydrophobized by known processes. Advantageously, the silica reinforcing fillers are subjected to an overall surface treatment. That means at least 50%, more preferably at least 80% or at least 90% of or especially preferably the entirety of the surface of silica reinforcing fillers is preferably hydrophobic treated.

In a preferred embodiment, the silica reinforcing filler is fumed silica with a specific surface area of at least 50 m²/g and preferably in the range from 100 to 400 m²/g as determined by the BET method. Fumed silica that is subjected to hydrophobic surface treatment may be used. In those cases, where a fumed silica that has undergone hydrophobic surface treatment is used, a fumed silica that has been subjected to preliminary hydrophobic surface treatment may be used. Alternatively a surface treatment agent may be added during mixing of the fumed silica with the organopolysiloxane compound A, so that the fumed silica is treated in-situ.

The surface treatment agent may be selected from one or more of the conventionally used agents, such as alkylalkoxysilanes, alkylchlorosilanes, alkylsilazanes, silane coupling agents, titanate-based treatment agents, and fatty acid esters. These surface treatment agents may be used either simultaneously or in order.

The amount of the silica reinforcing filler D in the treatment silicone composition is in the range from 0.5 wt % to 40 wt %, preferably 2 wt % to 20 wt % and more preferably 3 wt % to 15 wt % by weight of the total composition. If the amount is less than 1 wt %, the adequate thixotropy may not be obtainable and the collapse may not be noticeably reduced, whereas if exceeding 40 wt %, the actual blending process may become difficult and the electrical conductivity could be poor. More preferred amount as given above will lead to more remarkable improvements in respect to the collapse, deformation, conductivity and processability.

### Crosslinking inhibitor G

Crosslinking inhibitors are an optional component. But they are commonly used in addition crosslinking type silicone compositions to slow the curing of the composition at ambient temperature. The crosslinking inhibitor F may be chosen from the following compounds:
acetylenic alcohols such as ethynylcyclohexanol,
tetramethylvinyltetrasiloxane, such as 2,4,6,8-Tetramethyl-2,4,6,8-tetravinylcyclotetrasiloxane
pyridine,
organic phosphines and phosphites,
unsaturated amides, and
alkyl maleates.

These acetylenic alcohols, which are among the preferred hydrosilylation-reaction thermal blockers and described in such as FR-B-1528 464 and FR-A-2 372 874, have the formula: (R″)(R′″)(OH)C—C≡CH in which: R″ is a linear or branched alkyl radical, or a phenyl radical; R′″ is H or a linear or branched alkyl radical, or a phenyl radical; and the radicals R″ and R′″ and the carbon atom in α position to the triple bond may form a ring.

The total number of carbon atoms contained in R″ and R′″ is at least 5 and preferably from 9 to 20. For the said acetylenic alcohols, examples that may be mentioned include:
1-ethylnyl-1-cyclohexanol
3-methyl-1-dodecyn-3-ol;
3,7,11-trimethyl-1-dodecyn-3-ol;
1,1-diphenyl-2propyn-1-ol;
3-ethyl-6-1nonyn-3-ol;
2-methyl-3-butyn-2-ol;
3methyl-1pentadecyn-3-ol; and
diallyl maleate or diallyl maleate derivatives.

In a preferred embodiment, the crosslinking inhibitor is 1- ethynyl-1-cyclohexanol.

Advantageously, the amount of the crosslinking inhibitor F in the treatment silicone compositions is in the range from 0.01 wt % to 2 wt % weight, preferably from 0.03 wt % to 1 wt % weight with respect to the total weight of the silicone composition.

The use of the inhibitor is effective to avoid the premature curing of the silicone composition on the tip of the nozzle and subsequent disfiguration of the printed layer.

### Other Components H:

The silicone compositions according to the invention may also optionally comprise other additives like a standard semi-reinforcing or packing filler, other functional silicone resins such as silicone resin with vinyl group or cyclosiloxanes, non-reactive methyl polysiloxane, pigments, organic solvent or adhesion promoters.

Non siliceous minerals that may be included as semi-reinforcing or packing mineral fillers can be chosen from the group constituted of carbon black, titanium dioxide, aluminium oxide, hydrated alumina, calcium carbonate, ground quartz, diatomaceous earth, zinc oxide, mica, talc, iron oxide, barium sulfate and slaked lime.

It is desirable in the treatment silicone composition that the molar ratio of silicon-bonded hydrogen atoms (Si-H groups) to the sum of the silicon-bonded vinyl groups (Si-Vinyl groups) in whole composition, i.e. SiH/Vinyl is from 0.5 to 10 mol/mol, preferably from 0.6 to 5 mol/mol, more preferably from 0.8 to 4 mol/mol, from 1.2 to 4 mol/mol or from 1.6 to 4 mol/mol.

In one preferred embodiment, the building material or at least the material which the surface to be post treated is made from may be addition type silicone composition, just like the post treatment silicone composition, comprising also
(A) at least one organopolysiloxane compound A comprising, per molecule at least two C₂—C₆ alkenyl radicals bonded to silicon atoms,
(B) at least one organohydrogenopolysiloxane compound B comprising, per molecule, at least two hydrogen atoms bonded to an identical or different silicon atom, and
(C) at least one catalyst C comprising at least one metal from the platinum group or the compound thereof.

Therefore, the specification and preference given for the post treatment silicone composition and individual components contained therein as stated above apply also for the building material or the material which the surface to be post treated is made from. It has been found that the adhesion and mechanical property may kept excellent when using both addition type silicone compositions as specified above for the building material or material which the surface to be post treated is made from and the post treatment silicone composition.

Preferably, the building material or material which the surface to be post treated is made from may also possess the SiH/Vinyl from 0.5 to 10 mol/mol, preferably from 0.6 to 5 mol/mol, more preferably from 0.8 to 4 mol/mol, from 1.2 to 4 mol/mol or from 1.6 to 4 mol/mol.

As stated above, although the silicone composition used for the post treatment may have the relatively broad varying compositions, it is essential for the inventive beneficial technical effects such as removal of the step effect with maintaining good adhesion and mechanical properties to achieve a proper curing rate of the curable post-treatment silicone composition which may be controlled by adjusting the viscosity and preferably also the gel time of the curable material within the specified scopes. Such an adjustment is known to the skilled person. The specific viscosity and gel time scopes may be modified or optimized by varying the amounts of components mentioned above, including for example, mixing two organopolysiloxanes with high and low viscosity respectively e.g. adding more organopolysiloxane resin to increase the viscosity, adding or reducing the amount of some fillers like silica and so on. As for the required gel time, it may be achieved by adjusting the amount or type of the catalyst, crosslinking inhibitor or crosslinkable components.

Furthermore, the viscosity may be also varying depending on the curing temperature to be used. In one exemplary embodiment, the viscosity may be relatively low, for example, within the scope of 300 to 50 000 mPa·s for the curing temperature of about 23 ° C., or relatively high, for example, within the scope of 500 to 100 000 mPa·s or 2000-40 000 if the intended curing temperature is as high as about 150° C. or 180° C.

In a preferable embodiment, the post treatment silicone composition of the invention comprises, per 100% weight of the silicone composition:
(A) 5-95 wt % of said organopolysiloxane compound A,
(B) at least one said organohydrogenopolysiloxane compound B;
(C) 0.1-500 ppm of said catalyst C,
(D) 0-30 wt %, preferably 3-15 wt. % of said reinforcing silica filler D , and
(G) optionally at least one said crosslinking inhibitor G.

In a further advantageous embodiment, there needs less than 30 wt %, 1 wt % or 0.2 wt % or even no organic solvent in the inventive post treatment silicone composition. The omission of the organic solvent may make the post treatment silicone composition and thus the treated surface of the printed article more environmental friendly and less vulnerable to the bacteria. Therefore, the inventive post treatment silicone composition or the article treated thereby is suitable for the medical application such as an additive manufactured medical device or prosthetic appliance.

In the method according to the instant invention, the treatment silicone composition or the silicone composition used for the post treatment may be identical to or different from the composition of the material which the surface to be post treated is made from. In one embodiment, the silicone compositions used for post treatment of the surface and for additive manufacturing the object have the same composition.

In another aspect, the invention relates to a 3D printing process containing the post-treatment method as above, comprising the following steps:
a) fabricating an additive manufactured object having an exterior contour or surface of polymeric or plastic material, preferably the additive manufactured object made of polymeric or plastic material, more preferably made of silicone composition,
b) coating at least part of the surface of the fabricated object with a curable silicone composition as defined above, and
c) curing the coating at room temperature or by heat or UV radiation.

In the first step a), the object that is addictive manufactured usually has an uneven exterior surface or contour that has a visual step-like appearance. Preferably, the entire object is made of a polymeric or plastic material, preferably the silicone composition as indicated above.

Coating the curable silicone composition for post treatment may be carried out in different ways as long as a coating or a layer may be formed covering the exterior surface or contour that is to be treated. In one preferable embodiment, the fabricated object may be taken over and then dipped into a bath of the post treatment silicone composition. The dip coating may be carried out at different temperature, in particular at the room temperature. Finally, the dip coated object is taken out from the bath and forwarded to be cured.

The coated curable silicone composition may be then cured at room temperature or by heat or UV radiation. As for the room temperature or heat curing, the employed temperature may be from room temperature (about 23° C.) to higher e.g. 150° C. As for the UV radiation which may be used for curing, any UV light source may be employed such as a LED lamp or mercury lamp as long as it can provide the sufficient energy to cure the silicone composition. In one embodiment, the UV curing may be conducted for 0.001 s to 30 min, in particular for 0.1 s to 2 min.

With the inventive method, no mechanical surface treatments like blasting or polishing for making the surface even or removing the step effect may be needed in the 3D printing or additive manufacturing process, in particular between steps a) and b) or after step c).

The non-limiting examples which follow further illustrate the invention in more details.

### EXAMPLES

### Raw materials

TABLE 1
Raw materials of build materials and post-treatment agent

| Raw materials | Chemical description or structure |
|---|---|
| A-1 | Vinyl terminated Polydimethylsiloxane, viscosity: 230 mPa·s, vinyl content: 0.6 wt % |
| A-2 | Vinyl terminated Polydimethylsiloxane, viscosity: 600 mPa·s, vinyl content: 0.38 wt % |
| A-3 | Vinyl terminated Polydimethylsiloxane, viscosity: 1500 mPa·s, vinyl content: 0.26 wt % |
| A-4 | Vinyl terminated Polydimethylsiloxane, viscosity: 3500 mPa·s, vinyl content: 0.2 wt % |
| B-1 | Poly(methylhydrogeno)(dimethyl)siloxane with SiH groups in-chain and end-chain |
| | (α/ω), viscosity: 25 mPa·s, SiH content: 20 wt % |
| B-2 | Poly(methylhydrogeno) (dimethyl)siloxane with end-chain (α/ω) SiH groups, viscosity: 8.5 mPa·s, SiH content: 5.5 wt % |
| B-3 | Hydrogen-containing silicone resin, Si(O(CH3)2SiH)4 |
| C-1 | Pt catalyst: Platinum(0)-1,3-divinyl-1,1,3,3-tetramethyldisiloxane (Pt content: 10 wt %) |
| C-2 | Trimethyl(methylcyclopentadienyl)platinum(IV) HS161 CAS NO: 94442-22-5 |
| | 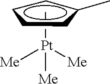 |
| D-1 | Treated silica, CAS NO: 68988-89-6 |
| E-1 | Methyl vinyl phenyl polysiloxane viscosity: 800 mPa·s, refractive index:1.46, vinyl content: 0.7%, phenyl content: 15% |
| | 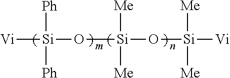 |
| F-1 | 2,4,6,8-Tetramethyl-2,4,6,8-tetravinylcyclotetrasiloxane, CAS NO.: 2554-06-5 |
| | 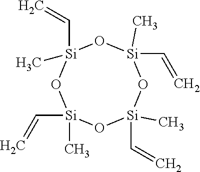 [SMILES: C=C[Si]1(C)O[Si](C)(C=C)O[Si](C)(C=C)O[Si](C)(C=C)O1] |
| F-2 | Ethynylcyclohexanol, CAS NO.: 78-27-3 |
| | 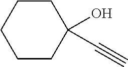 |
| G-1 | Diethylene glycol monobutyl ether acetate CAS NO.: 124-17-4 |
| | 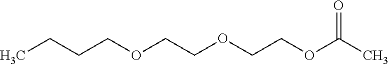 |

### Descriptions of the Measurements

Viscosity: According to ASTM D445, the viscosity of the sample mixture is tested at 23 ° C., the details of testing conditions can be seen in the tables 2 and 4, in which, for example, the expression “(5#, 20 rpm)” means that the viscosity is measured at 20 rpm by using spindle number 5, and so on.

Tensile strength and Elongation at break: Tensile strength and elongation at break of cured samples are tested at 23 ° C. according to ASTM D412. The details of testing conditions can be seen in the table 3. The cured sample was obtained under 150 ° C. for 1 hour.

Tear strength: Tear strength of cured samples are tested at 25 ° C. according to ASTM D642. The details of testing conditions can be seen in the table 4. The cured sample was obtained under 150 ° C. for 1 hour.

Gel time: Using a similar method according to the standard D2471-99 for the thermosetting resin, in which a clean probe is used to contact with the tested material frequently from the beginning of mixing under room temperature or UV radiation and the time until the material no longer adheres to the end of a clean probe is recorded as the gel time.

Removal of step effect: conducting visual assessment on the situation of step effect and making scores with asterisks: *** no visible steps on the surface and smooth; ** a little step effect and relatively uneven; * uneven and obvious step effect

### Preparation of an Additive Manufactured Article

3D printing process was carried out by using an extrusion printer according to the following procedure:
I. Loading the building material as shown in table 1 into an extruder;
II. Level adjusting the printing platform and setting the following printing parameters:
   Extruder die T1: 0.25 mm
   Scanning speed: 1000 mm/min
   Layer thickness: 0.3 mm and
   Flow rate: 0.10 ml/min

A printed cube with 15 millimeter of side-length was obtained, having the surface of an obvious step effect.

TABLE 1
Building materials for the additive manufactured object

| Components | Weight parts |
|---|---|
| A-1 | 7.08 |
| A-3 | 59.53 |
| B-3 | 4.5 |
| C-1 | 0.02 |
| D-1 | 25.52 |
| E-1 | 2.5 |
| F-1 | 0.8 |
| F-2 | 0.05 |
| TOTAL | 100.000 |
| SiH/Vinyl | 2.1 |
| Ratio | |

### Preparation of Post Treatment Silicone Composition

Example 1 was prepared as follows: 1 part of E-1 and 0.8 part of F-1 were added into the mixture of 21 parts of α, ω-vinylsiloxane oil A3 and 60.12 parts of α, ω-vinylsiloxane oil A4 with enough agitation. 0.06 part of inhibitors F-2 was added into the mixture, followed by addition of 8 parts of polydimethylsiloxane with SiH groups B-1. Then, 9 parts of silica D-1 was mixed thoroughly with the above mixture. Finally, 0.02 parts of catalyst C-1 was added to obtain example 1.

Example 2-12 were likewise prepared according to Example 1 except varying the amounts of the components as shown in tables 2 and 3.

Example 13 was a control example which was not post treated by the inventive silicone composition.

### Coating and Curing of the Post Treatment Silicone Composition

The printed cube was dipped into the bath of each of the prepared post-treatment agents (silicone compositions) and then was left to stay at room temperature until there is no droplet dripping from the article, exhibiting a uniform treatment layer. Several coated articles in examples 6 to 15 were cured by heat under the conditions simply specified in table 4. The coated article in example 5 was subjected to a UV curing process.

UV curing process: The sample stayed under UV irradiation for 3 seconds to obtain a smooth surface. The sample was beamed by UV Hg lamp.

| | | |
|---|---|---|
| Light power: 120 w/cm | 20 | m/min, |
| UV A: 147.7 mJ/cm² | 1417.9 | mw/cm² |
| UV B: 112.8 mJ/cm² | 1092.8 | mw/cm² |
| UV C: 33.4 mJ/cm² | 321.9 | mw/cm² |
| UV V: 192.7 mJ/cm² | 1840.7 | mw/cm² |

The distance between light source and the sample is 10 cm. When the sample was beamed for 3s, the sample lost fluidity and rapidly formed.

The mechanical performance before and after post treatment on the 3D printed cube with the silicone composition prepared in example 4 was measured and the results were shown in table 3.

Furthermore, examples 1 to 4 were subjected to the heat curing under 150 ° C. for one hour and the cured post treatment silicone coating on the surface could not be peeled off by hand, showing the good adhesion.

TABLE 2

| Components | Example 1 | Example 2 | Example 3 | Example 4 |
|---|---|---|---|---|
| A-2 | 0 | 0 | 0 | 46.52 |
| A-3 | 21 | 21 | 21 | 35 |
| A-4 | 60.12 | 60.12 | 65.02 | 0 |
| B-1 | 8 | 8 | 4.1 | 3.4 |
| C-1 | 0.02 | 0.02 | 0.02 | 0.02 |
| D-1 | 9 | 9 | 9 | 15 |
| E-1 | 1 | 0 | 0 | 0 |
| F-1 | 0.8 | 0.8 | 0.8 | 0 |
| F-2 | 0.06 | 0.06 | 0.06 | 0.06 |
| TOTAL | 100.000 | 99.000 | 100.000 | 100.000 |
| SiH/Vinyl Ratio | 3.3 | 3.4 | 1.7 | 2 |
| Viscosity/mPa · s | 11000 | 10000 | 9000 | 12000 |
| 5#, 20 rpm, 23° C. | | | | |
| Adhesion on the | Good | Good | Good | Good |
| cube | adhesion | adhesion | adhesion | adhesion |

TABLE 3
The mechanical performance before and
after post treatment based on example 4

| | Before treatment | After treatment |
|---|---|---|
| Tear strength/N/mm | 10 | 10 |
| Tensile strength/MPa | 5.2 | 4 |
| Elongation at break/% | 89 | 83 |

TABLE 4

| Components | Example 5 | Example 6 | Example 7 | Example 8 | Example 9 | Example 10 | Example 11 | Example 12 | Example 13 |
|---|---|---|---|---|---|---|---|---|---|
| A-2 | 82.87 | 82.95 | 82.95 | 82.77 | 82.77 | 8.9 | 8.9 | 82.56 | 0 |
| A-3 | 0 | 0 | 0 | 0 | 0 | 43.4 | 43.4 | 0 | 0 |
| A-5 | 0 | 0 | 0 | 0 | 0 | 26.67 | 26.67 | 0 | 0 |
| B-1 | 5 | 5 | 5 | 5 | 5 | 2.2 | 2.2 | 4.97 | 0 |
| C-1 | 0 | 0.03 | 0.03 | 0.03 | 0.03 | 0.03 | 0.03 | 0.03 | 0 |
| C-2 | 0.03 | 0 | 0 | 0 | 0 | 0 | 0 | 0 | 0 |
| D-1 | 11.98 | 12 | 12 | 12 | 12 | 18.6 | 18.6 | 11.94 | 0 |
| F-2 | 0 | 0.02 | 0.02 | 0.2 | 0.2 | 0.2 | 0.2 | 0.5 | 0 |
| G-1 | 0.12 | 0 | 0 | 0 | 0 | 0 | 0 | 0 | 0 |
| Total | 100 | 100 | 100 | 100 | 100 | 100 | 100 | 100 | 0 |
| SiH/Vinyl | 2.9 | 2.9 | 2.9 | 2.9 | 2.9 | 1.9 | 1.9 | 2.9 | |
| Ratio | | | | | | | | | |
| Viscosity/mPa · s | 2200 | 2200 | 2200 | 2200 | 2200 | — | — | 2200 | — |
| 23° C., 5# | | | | | | | | | |
| 20 rpm | | | | | | | | | |
| Viscosity/mPa · s | — | — | — | — | — | 100000 | 100000 | — | — |
| 23° C., 5# | | | | | | | | | |
| 3 rpm | | | | | | | | | |
| Gel time at | — | 0.2 | 0.2 | 12 | 12 | 12 | 12 | 300 | — |
| 23° C./h | | | | | | | | | |
| Treatment | *** | | | | | | | | |
| results/UV × | | | | | | | | | |
| 3 s | | | | | | | | | |
| Treatment | | *** | | | | | | | |
| results/23° C. × | | | | | | | | | |
| 60 min | | | | | | | | | |
| Treatment | | | | ** | | ** | | | |
| results/23° C. × | | | | | | | | | |
| 24 h | | | | | | | | | |
| Treatment | | | *** | | ** | | ** | * | |
| results/150° C. × | | | | | | | | | |
| 2 min | | | | | | | | | |
| Untreated | | | | | | | | | * |

1. A method of post treatment of at surface of an additive manufactured object, the method comprising the steps of coating at least part of the surface with a curable silicone composition and then curing the coating at room temperature, by heat and/or UV radiation, wherein the curable silicone composition has a viscosity in a range from 300 mPA·s to 500 000 mPa·S.

2. The method according to claim 1, wherein the surface to be post treated is a polymeric or plastic material.

3. The method according to claim 1 wherein gel time of the curable silicone composition is for the room temperature or heat curing in a range from 0.1 second to 15 hours; and for the UV radiation curing in a range from 0.001 second to 1 hour.

4. The method according to claim, wherein no mechanical surface treatment, including blasting or polishing, are carried out before or after said post treatment.

5. The method according to claim 1, wherein the surface to be treated is dipped into a bath of the curable silicone composition.

6. The method according to claim 1, wherein the curable silicone composition, which is coated on the surface, is cured at room temperature or by heat.

7. The method according to claim 1, wherein the curable silicone composition, which is coated on the surface, is cured by UV radiation

8. The method according to claim 1, wherein the curable silicone composition for the post treatment comprises
(A) at least one organopolysiloxane compound A comprising, per molecule at least two C₂—C₆ alkenyl radicals bonded to silicon atoms, (B) at least one organohydrogenopolysiloxane compound B comprising, per molecule, at least two hydrogen atoms bonded to an identical or different silicon atom, and (C) at least one catalyst C comprising at least one metal from the platinum group or the compound thereof.

9. The method according to claim 1, wherein molar ratio of SiH/Vinyl in the silicone composition for post treatment is from 0.5 mol/mol to 10 mol/mol.

10. The method according to claim 1, wherein the curable silicone composition for the post treatment is identical to or different from the composition of the material which the surface to be post treated is made from.

11. A method of reducing unevenness of a surface of an additive manufactured object, the method comprising reducing the unevenness with the curable silicone composition as defined in claim 1.

12. A post-treatment agent for an additive manufactured object, wherein the agent comprises the curable silicone composition as defined in claim 1.

13. A 3D printing process comprising method according to claim 1, and further comprising the following steps:
a) fabricating an additive manufactured object having an exterior contour or surface of polymeric or plastic material,
b) coating at least part of the surface of the fabricated object with a curable silicone composition as defined in claim 1, and
c) curing the coating at room temperature, by heat and/or by UV radiation.

14. The method according to claim 11, wherein no mechanical surface treatment, including blasting or polishing, is carried out between steps a) and b) or after step c).

15. A method of making an additive manufactured medical device or prosthetic appliance, the method comprising making the device or appliance using of the post treatment agent or the article treated by the post treatment agent as defined in claim 11.

16. The method according to claim 1, wherein the curable silicone composition has the viscosity of from 500 mPa·s to 200 000 mPAs.

17. The method according to claim 16, wherein the viscosity is from 800 mPA·s to 90 000 mPA·s.

18. The method according to claim 16, wherein the viscosity is from 1000 mPA.s to 50 000 mPA·s.

19. The method according to claim 16, wherein the viscosity is from 1000 mPA·s to 20 000 mPA·s.

20. The method according to claim 2, wherein the surface to be post treated is silicone rubber.

21. The method according to claim 3, wherein the gel time is 1 second to 0.5 hour.

22. The method according to claim 3, wherein the gel time is 5 seconds to 10 minutes.

23. The method according to claim 3, wherein the gel time is 10 seconds to 2 minutes.

24. The method according to claim 3, wherein the UV radiation curing is in a range from 0.01 second to 20 minutes.

25. The method according to claim 3, wherein the UV radiation curing is in a range from 0.1 second to 1 minute.

26. The method according to claim 6, wherein the curing at room temperature or by heat is at a temperature from 23° C. to 180° C.

27. The method according to claim 7, wherein the curing by UV radiation is conducted for a duration of from 0.001 second to 30 minutes.

28. The method according to claim 7, wherein the curing by UV radiation is conducted for a duration of from 0.1 second to 2 minutes.

29. The method according to claim 9, wherein the molar ratio is from 0.6 mol/mol to 5 mol/mol.

30. The method according to claim 9, wherein the molar ratio is from 0.8 mol/mol to 4 mol/mol.

31. The method according to claim 9, wherein the molar ratio is from 1.2 mol/mol to 4 mol/mol.

32. The method according to claim 9, wherein the molar ratio is from 1.6 mol/mol to 4 mol/mol.

33. The 3D printing process of claim 13, wherein the additive manufactured object is made of polymeric and/or plastic material.

34. The 3D printing process of claim 13, wherein the additive manufactured object is made of silicone composition it's easy to fix
